(19) United States
(12) Patent Application Publication
(10) Pub. No.: US 2017/0359651 A1
(43) Pub. Date: Dec. 14, 2017

(54) Directional Microphone System

(71) Applicant: Xedit Corporation, Queens Village, NY (US)

(72) Inventor: Claude M. Karczmer, Queens, NY (US)

(73) Assignee: Xedit Corporation, Queens Village, NY (US)

(21) Appl. No.: 15/617,349

(22) Filed: Jun. 8, 2017

Related U.S. Application Data
(60) Provisional application No. 62/347,244, filed on Jun. 8, 2016.

(51) Int. Cl. H04R 1/40; H04R 1/08

(52) U.S. Cl. CPC H04R 1/406; H04R 1/083; H04R 2201/401

(57) ABSTRACT

A directional microphone system includes a microphone assembly designed to be mounted from a ceiling or other raised surface through a reeling mechanism used to deploy the microphone assembly to a lowered position, preferably just above eye level of a speaker. The microphone assembly includes an outer housing encapsulating multiple audio detection elements or capsules which are specifically angled relative to each other and the horizontal in order to optimize targeted audio reception. With a preferred arrangement, three audio detection (microphone) elements are secured through with a wishbone frame mounted in the outer housing, with each element being at about a 60° angle to the horizontal to provide enhanced horizontal coverage.

### BACKGROUND OF THE INVENTION

The present invention pertains to the field of acoustics and, more particularly, to a directional microphone system for capturing audio signals. There are a number of multi-element microphones on the market. Typically, such microphones are employed in large meeting or lecture rooms, halls and the like of buildings where rather large groups of people gather for speaking engagements. Of particular concern to the present invention is the type of microphones generally referred to as “ceiling microphones”. In general, with these types of microphones, no distinction is made to differentiate microphones that are actually installed at the ceiling, or those that hang down for a short distance from the ceiling. Regardless, these microphones are intended to hang relatively high above the individuals speaking.

For example, such a microphone system would typically be employed in a board room. When a meeting is conducted using the microphone system, various potential speakers would be seated around a boardroom table, with various microphones hanging down from the ceiling to a fixed height well above the individuals. The microphones are internally designed to aim the microphone elements downward at varying downward angles from a flat 10 degrees of downward pitch to a maximum of roughly 45 degrees from horizontal, typically from a horizontal ceiling plane. With these microphones positioned well above the individuals and relatively closer to the ceiling, typically a source of noise, the audio quality can also be compromised due to distance and impaired horizontal coverage. At this high position the microphones often pick up more ambient or surrounding noise along with the audio from the intended speaker. In addition, known microphones of this type tend to be quite large or bulky, generally being greater than two inches in diameter, resulting in a rather unpleasant eye-sore in what is intended to be an aesthetically pleasing environment. Although it is possible to mount the microphones utilizing retractable reeling mechanisms so as to enable the height of the microphones relative to the individuals to be adjusted, audio quality would be compromised under these circumstances due to the known internal microphone element configuration and the overall bulky nature of these microphones makes lowering such microphones considerably less desirable.

### SUMMARY OF THE INVENTION

The directional microphone system of the invention includes a microphone assembly designed to be mounted from a ceiling or other raised surface through a reeling mechanism which is used to deploy the microphone to a lowered position just above eye level in order to obtain better audio signals. That is, the overall microphone system includes a servo-based reeler mounted to the ceiling or other raised surface mount, with the microphone assembly being attached to a cable which can be selectively extended or retracted from a housing of the servo-based reeler. With this arrangement, the microphone assembly can be readily deployed at an optimal height for audio reception, i.e., slightly above eye level height resulting in less room noise and improved audio presence. In particular in accordance with the invention, the microphone assembly includes an outer housing encapsulating multiple audio detection elements or capsules which are specifically angled relative to each other and the horizontal in order to optimize targeted audio reception.

In accordance with a preferred embodiment of the invention, the housing of the microphone assembly takes a spherical or ball-shaped configuration, with the spherical microphone assembly being composed of two connected machined hemispheres. The top or upper hemisphere encompasses a microphone cable anchor system including a threaded center post that restrains the microphone cable when the post is tightened into the top hemisphere. In addition, a bottom or lower hemisphere is provided with a series of openings or screens for the microphone elements. Within the housing is mounted a wishbone frame including a base secured to the bottom hemisphere and a plurality of upstanding, bifurcated legs. Preferably, each leg is angled at about 60° to the horizontal and supports a rubber grommet carrying a respect one of the audio detection elements. Most preferably, the wishbone frame includes three legs which are spaced 120° apart such that the microphone assembly incorporates three spaced and angled audio detection elements mounted in vibration isolation through the grommets in opposition to the series of openings or screens. Overall, the microphone assembly is quite small, preferably having an outer diameter of less than one inch (1″) and, more preferably, in the order of ⅞″. With this preferred arrangement, three audio detection (microphone) elements are secured through with wishbone frame, with the angle for each element preferably being preferably at 60° from horizontal which has been found to significantly enhance the ability of the microphone assembly to provide a wider horizontal coverage.

Additional objects, features and advantages of the invention will become more readily apparent from the detailed description presented below, when taken in conjunction with the drawings wherein like reference numerals refer to corresponding parts in the several views.

### BRIEF DESCRIPTION OF THE DRAWINGS

FIG. 1 illustrates a directional microphone system including a microphone connected to a reeling mechanism constructed in accordance with the invention.

FIG. 2 is an exploded view of components of the microphone of FIG. 1.

FIG. 3 is a partial exploded view of outer housing components of the microphone.

FIG. 4 is a bottom plan view of one of the outer housing components of FIG. 3.

FIG. 5 is an assembled, perspective view of various internal components from FIG. 2.

FIG. 6 is a cross-sectional view of the microphone of FIG. 1.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention. In addition, any specific numerical value listed herein includes a margin of error of +/−5%. Accordingly, an angle of 60° includes angles between 57° and 63°. The term “about” increases the margin of error to 10%.

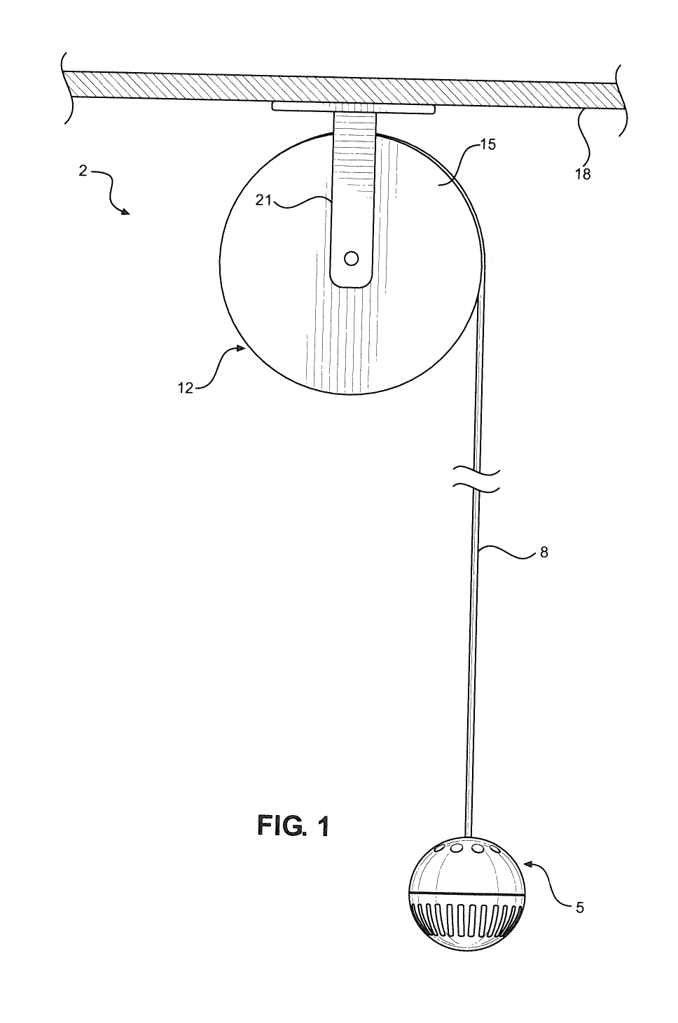

With initial reference to FIG. 1, a microphone system constructed in accordance with the present invention is generally indicated at 2. Microphone system 2 includes a microphone assembly 5 connected through a cable 8 to a reeling mechanism 12. In general, reeling mechanism 12 can take various forms known in the art, including various reelers sold by the XEDIT Corporation, such that the details thereof are not important to the particular invention. In general, however, reeling mechanism 12 is shown to include a housing 15 for cable 8 which can be selectively retracted into and deployed from housing 15 either manually or electrically. In the representative embodiment shown, housing 15 is supported from a ceiling 18 through a bracket 21.

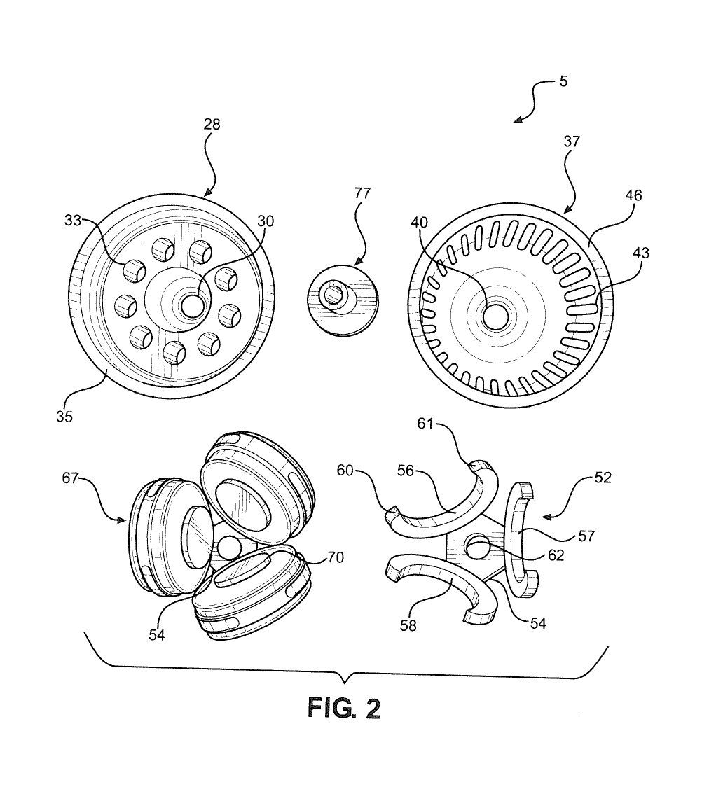

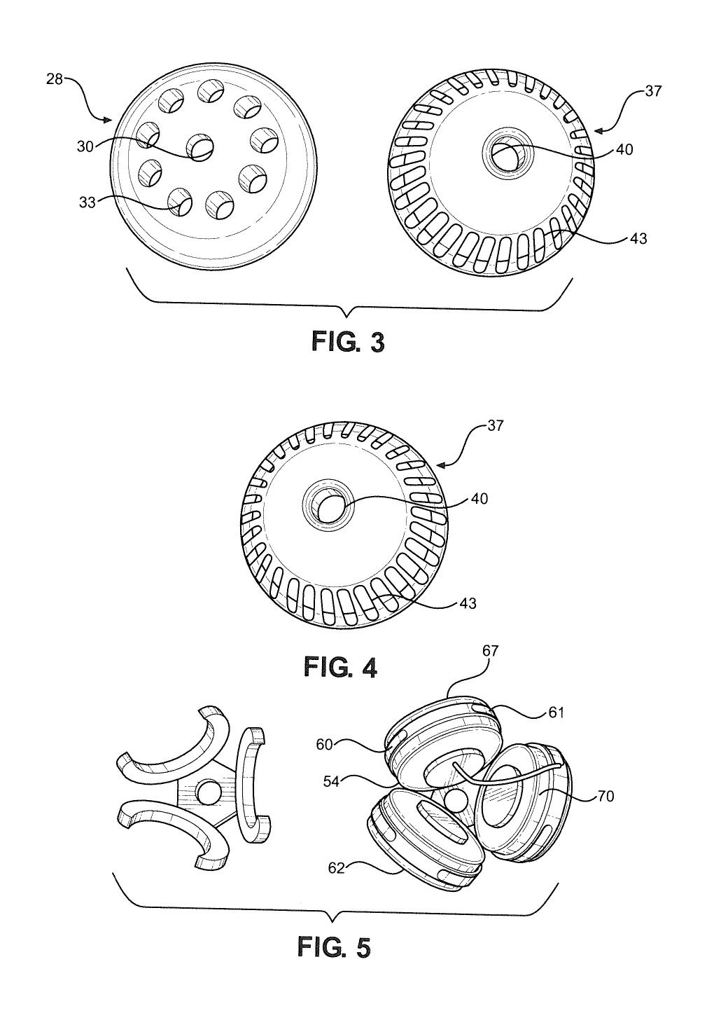

With particular reference to FIGS. 2-4, a preferred construction for microphone assembly 5 will now be provided. As depicted, microphone assembly 5 is spherical in shape, including a top or upper hemisphere portion 28 provided with an upper central bore 30 surrounded by a plurality of circumferentially spaced through holes 33 which are provided for venting purposes. As best shown in FIG. 2, top hemisphere portion 28 also establishes a lower peripheral surface 35. Microphone assembly 5 also includes a bottom or lower hemisphere portion 37 including a lower central bore 40, as well as a series of circumferentially spaced openings 43 provided adjacent an upper peripheral surface 46. At this point, it should be noted that upper and lower hemisphere portions 28 and 37 can be formed from of a wide range of materials. In a preferred form, upper and lower hemisphere portions 28 and 37 are machined of metal. In addition, upper and lower hemisphere portions 28 and 37 can be attached together in various ways, with one preferred arrangement being detailed below after describing internal structure of microphone assembly 5.

With particular reference to FIG. 2, microphone assembly 5 is preferably provided with a wishbone frame 52 including a base 54 and a plurality of upstanding legs 56-58, each of which is bifurcated so as to including a first leg portion 60 and a second leg portion 61. As shown, base 54 of frame 52 is formed with an aperture 62. In addition to frame 52, microphone assembly 5 employs a plurality of grommets, one of which is indicated at 67, with each grommet 67 being made from an elastomeric material such as rubber. Mounted within a central opening formed in each grommet 67 is an audio detection element or capsule 70. As will be detailed more fully below, microphone assembly 5 also includes a center post generally indicated at 77.

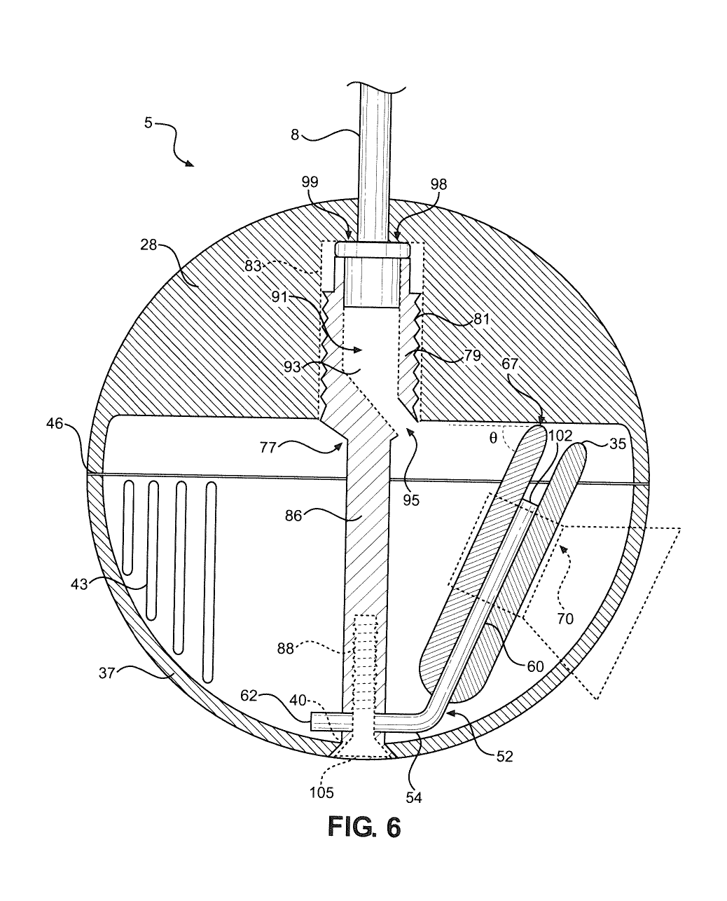

As best shown in FIG. 6, center post 77 includes an upper end 79 which is externally threaded at 81 and mates with an internally threaded recess 83 of upper hemisphere portion 28. Center post 77 also includes a shaft portion 86 which extends from upper end 79 and has a terminal end portion (not separately labeled) which is provided with an internally threaded bore 88. Upper end 79 is also shown to include an internal channel 91 having a first diametric portion 93 leading to a second, angled and reduced diametric portion 95 which establishes a conductor passage.

As seen in this figure, cable 8 extends through central bore 30 of upper hemisphere portion 28 and has crimped or otherwise fixed thereto a fitting 98 including a flange 99. Upper end 79 of center post 77 is threaded within recess 83, with flange 99 being sandwiched between upper hemisphere portion 28 and a top of center post 77, while the remainder of fitting 98 extends into first diametric portion 93 of internal channel 91. As such, the fitting 98 is held captive to securely anchor the microphone assembly 5. With each grommet 67 supporting a respective audio detection element 70, an annularly reduced central portion 102 of the grommet 67 is arranged between the first and second leg portions 60 and 61 of a respective bifurcated leg 56-58 (also see FIG. 5), with wires (not shown) extending from cable 8 being electrically connected to each audio detection element 70. Once assembled in this manner, base 54 of frame 52 is positioned against shaft portion 86 of center post 77, lower hemisphere portion 37 is placed about wishbone frame 52 such that upper surface 46 abuts lower peripheral surface 35 and central bore 40 is aligned with aperture 62 in base 54. Thereafter, a mechanical fastener, such as a screw 105, is inserted through central bore 40 and aperture 62, and then threaded or otherwise extended into bore 88 of shaft 86 to fixedly secure upper and lower hemisphere portions 28 and 37 together with frame 52 therein.

With this overall arrangement, wishbone frame 52 has the generally U-shaped legs 56-58 arranged 120 degrees apart, with each leg 56-58 being angled at about 60 degrees relative to horizontal or about 30 degrees to the vertical. At the same time, the grommets 67 act as both isolation and insulation mounts for the audio detection elements or capsules 70, while assuring that the audio detection elements 70 cannot make electrical contact with any metal of upper or lower hemisphere portions 28, 37. In addition, through holes 33 provide venting to assure proper functioning of cardioid elements, and openings 43 are arranged juxtapose audio detection elements 70 to enable clean and clear audio reception. Furthermore, as indicated above, the microphone assembly 5 is quite small, preferably having an outer diameter of less than one inch (1″) and, more preferably, in the order of ⅞″. In any case, although described with reference to preferred embodiments of the invention, it should be recognized that various changes and/or modification can be made without departing from the spirit of the invention as encompassed by the claims.

1. A directional microphone system comprising:
a reeling mechanism configured to be mounted from a ceiling or other raised surface above a speaker, said reeling mechanism including a reeler housing and a cable which can be selectively extended or retracted from the reeler housing; and
a microphone assembly attached to the cable such that the microphone assembly is lowered when the cable is extended from the reeler housing, said microphone assembly including an outer housing encapsulating multiple audio detection elements, with each audio detection element being at an angle of about 60° to horizontal.

2. The directional microphone system of claim 1, wherein the angle is 60°.

3. The directional microphone system of claim 1, wherein the audio detection elements are also angled relative to each other.

4. The directional microphone system of claim 3, wherein the audio detection elements are angled about 120° relative to each other.

5. The directional microphone system of claim 1, wherein the outer housing includes an upper portion attached to a lower portion.

6. The directional microphone system of claim 5, wherein the outer housing takes the form of a sphere, with the upper and lower portions being hemispherical and with the sphere having an outer diameter of less than one inch.

7. The directional microphone system of claim 5, wherein the upper portion of the outer housing includes an upper central bore into which the cable extends.

8. The directional microphone system of claim 7, wherein the upper portion of the outer housing includes a plurality of circumferentially spaced vent holes.

9. The directional microphone system of claim 7, wherein the microphone assembly further including:
a lower central bore provided in the lower portion of the outer housing;
a recess provided internally within the upper portion of the outer housing;
a center post having an upper end extending into the recess; and
a mechanical fastener extending within the lower central bore and secured to the center post.

10. The directional microphone system of claim 9, wherein the upper end of the center post is fixed in the recess such that the center post and mechanical fastener secure the upper and lower portions of the outer housing together.

11. The directional microphone system of claim 9, wherein the center post includes an internal channel in the upper end establishing a conductor passage for electrically interconnecting the cable and the audio detection elements.

12. The directional microphone system of claim 1, wherein the microphone assembly further includes a wishbone frame having a base and a plurality of upstanding legs, with the plurality of upstanding legs supporting the audio detection elements within the outer housing.

13. The directional microphone system of claim 12, wherein each leg of the wishbone frame is bifurcated to include a first leg portion and a second leg portion, with each of the audio detection elements being mounted between a respective said first leg portion and said second leg portion.

14. The directional microphone system of claim 13, wherein the microphone assembly further includes a grommet for mounting a respective said audio detection element between a respective said first leg portion and said second leg portion of the wishbone frame with the grommet being interposed between the leg of the wishbone frame and the respective said audio detection element.

15. The directional microphone system of claim 14, wherein the grommet includes an annularly reduced central portion arranged between the respective said first leg portion and said second leg portion.

16. A method of detecting audio signals from a speaker comprising:
extending a cable of a reeling mechanism mounted from a ceiling or other raised surface above the speaker such that a microphone assembly, which is attached to the cable and includes an outer housing encapsulating multiple audio detection elements with each audio detection element being at an angle of about 60° to horizontal, is lowered for detecting audio signals from the speaker.

17. The method of claim 16, wherein the microphone assembly is lowered to just above eye level of the speaker.

18. The method of claim 16, wherein audio signal from the speaker are detected with the audio detection elements being angled about 120° relative to each other.

19. The method of claim 16, wherein the audio detection elements are isolated and insulated through grommets mounting the audio detection elements within an outer housing of the microphone assembly.

20. The method of claim 16, wherein lowering the microphone assembly constitutes lowering a sphere containing the multiple audio detection elements, with the sphere having an outer diameter of less than one inch.
